(19) United States
(12) Patent Application Publication
(10) Pub. No.: US 2023/0228785 A1
(43) Pub. Date: Jul. 20, 2023

(54) SENSOR SYSTEM FOR A VEHICLE

(71) Applicant: Robert Bosch GmbH, Stuttgart (DE)

(72) Inventors: Jo Pletinckx, Sersheim (DE); Jan Schnee, Weil Im Schoenbuch (DE); Adrian Kussmann, Filderstadt (DE)

(21) Appl. No.: 18/152,871

(22) Filed: Jan. 11, 2023

(30) Foreign Application Priority Data
Jan. 20, 2022 (DE) 10 2022 200 617.8

(51) Int. Cl. G01P 3/487; A63B 69/16

(52) U.S. Cl. CPC G01P 3/487; A63B 69/16; A63B 2220/34; A63B 2220/36; A63B 2069/164

(57) ABSTRACT

A sensor system for a bicycle. The system system includes a magnetic field sensor and an acceleration sensor unit having at least one acceleration sensor, and an evaluation unit that is designed to acquire signals from the magnetic field sensor and the acceleration sensor unit. The magnetic field sensor and the acceleration sensor unit are designed for attachment to a wheel of the bicycle. The magnetic field sensor and the acceleration sensor unit are fixed relative to each other and are situated at a predefined distance with respect to an axis of rotation. The evaluation unit is designed to evaluate the signals of the magnetic field sensor and the acceleration sensor unit to ascertain a rotational speed and/or orientation of the magnetic field sensor and/or acceleration sensor unit with respect to the axis of rotation.

### CROSS REFERENCE

The present application claims the benefit under 35 U.S.C. 119 of German Patent Application No. DE 10 2022 200 617.8 filed on Jan. 20, 2022, which is expressly incorporated herein by reference in its entirety.

### FIELD

The present invention relates to a sensor system for a bicycle. Furthermore, the present invention relates to a bicycle having such a sensor system. In particular, the sensor system is used to ascertain a rotational speed of a wheel of the bicycle.

### BACKGROUND INFORMATION

A commonly used sensor for determining the speed of a bicycle is the so-called Reed sensor. This sensor supplies one signal per complete revolution of the rear wheel of the bicycle, triggered by a magnet attached to the wheel. From the time difference between two such pulses and using the known wheel circumference, the speed at the rear wheel can be determined.

Another measurement principle for determining speeds uses the temporal change of the measured magnetic field when a magnetic sensor rotates in the earth's magnetic field. For this purpose, the sensor is attached to the hub of the rear wheel. When the wheel rotates, the sensor acquires a rotating field. The amplitude and the rotational speed of the field or of the sensor can then be determined using a multi-axis magnetic field sensor.

### SUMMARY

The sensor system according to the present invention for a bicycle, in particular for an e-bike, enables a safe and reliable ascertaining of a speed of the bicycle by ascertaining a speed of a wheel of the bicycle. According to an example embodiment of the present invention, this is preferably done through a combination of a rotating magnetic field sensor and a rotating acceleration sensor unit. If only a magnetic field sensor were used, the ascertaining of the speed could be disturbed by an artificially generated magnetic field, generated for example by one or more current-conducting coils or one or more permanent magnets, which is prevented by the acceleration sensor unit. The use of an acceleration sensor unit as a further sensor design independent of the measured magnetic field enables a checking of the speed ascertained by the magnetic field sensor.

Furthermore, by fusing the two sensor signals, not only the average speed per wheel revolution but also the relative position of the wheel within one revolution can be better estimated. This allows the speed of the wheel to be determined more frequently than once per complete wheel revolution.

According to an example embodiment of the present invention, the sensor system has a magnetic field sensor and an acceleration sensor unit having at least one acceleration sensor. In addition, the sensor system has an evaluation unit. The evaluation unit is designed to acquire signals from the magnetic field sensor and the acceleration sensor unit.

It is provided that the magnetic field sensor and the acceleration sensor unit are designed to be attached to a wheel of the bicycle. When the bicycle is moved, the magnetic field sensor rotates in the earth's magnetic field, while a centrifugal acceleration also acts on the acceleration sensor unit. In addition, the acceleration sensor unit rotates relative to the Earth's gravitational force. The signals ascertained by the magnetic field sensor and the acceleration sensor unit are thus a function of the rotation of the wheel, making it possible to ascertain characteristic variables of this rotation. Furthermore, it is provided that the magnetic field sensor and the acceleration sensor unit are fixed relative to each other and situated with a predefined distance with respect to an axis of rotation. The evaluation unit is designed to evaluate the signals of the magnetic field sensor and the acceleration sensor unit in order to ascertain a rotational speed and/or orientation of the magnetic field sensor and/or acceleration sensor unit with respect to the axis of rotation. The evaluation unit can thus ascertain both a speed of the wheel and an orientation of the wheel, based on different sensor designs. Due to the different measurement principles, on the one hand an accuracy of the measurement is increased, while on the other hand a disturbance of the measurement is made more difficult.

Preferred developments of the present invention are disclosed herein.

Preferably, according to an example embodiment of the present invention, it is provided that the acceleration sensor unit has a first acceleration sensor and a second acceleration sensor, which are stationary relative to each other and are situated in different angular positions with respect to the axis of rotation. This enables various components of the measured acceleration to be mutually balanced or calculated in order to enable the rotational speed about the axis of rotation to be ascertained solely from the centrifugal acceleration of the acceleration sensors. These components are produced for example by gravitational acceleration or by impacts due to uneven ground. This simplifies the ascertaining of the speed by the evaluation unit.

Particularly advantageously, according to an example embodiment of the present invention, the first acceleration sensor and the second acceleration sensor are configured in mirror-symmetrical fashion with respect to the axis of rotation. This leads to a direct determination of all components of the acceleration, with the exception of the centrifugal acceleration. By combining the measured sensor signals of the acceleration sensors, it is thus possible to directly ascertain the centrifugal acceleration, which is a direct measure of the rotational speed of the acceleration sensor unit about the axis of rotation.

In a preferred embodiment of the present invention, the sensor system has an additional acceleration sensor. The additional acceleration sensor is stationary with respect to the axis of rotation and is therefore not stationary relative to the acceleration sensor unit. The evaluation unit is designed in particular to ascertain a centrifugal acceleration from the signals of the acceleration sensor unit on the basis of signals of the additional acceleration sensor. Thus, the signals of the acceleration sensor unit contain further acceleration components that act on the entire sensor system and are not caused by the rotation about the axis of rotation. These components can be acquired by the stationary additional acceleration sensor and calculated from the signals of the acceleration sensor unit. The result thus contains only the centrifugal acceleration due to the rotation of the acceleration sensor unit. This therefore enables the evaluation unit to ascertain the rotational speed in a simplified manner.

According to an example embodiment of the present invention, the evaluation unit preferably has a fusion unit. In particular, the fusion unit is a Kalman filter. The fusion unit is designed to fuse the signals of the magnetic field sensor and the acceleration sensor unit in order to ascertain a rotational speed and/or orientation of the magnetic field sensor and/or acceleration sensor unit with respect to the axis of rotation from the fused signals. The data fusion thus enables an accurate and robust ascertaining of the speed, in particular because data from independent measurement principles are fused.

According to an example embodiment of the present invention, the evaluation unit is preferably designed to perform a first speed ascertainment based on signals from the magnetic field sensor and a second speed ascertainment based on signals from the acceleration sensor unit. In addition, the evaluation unit is preferably designed to output an error message if the results of the first speed ascertainment and the second speed ascertainment differ by more than a predefined tolerance. In this way, on the one hand deliberate manipulations of the magnetic field sensor can be ascertained. This is particularly relevant if the sensor system is used in an e-bike that provides motorized support only up to a predefined speed threshold. If the error message is outputted, it is preferably provided that a motorized support of the e-bike is terminated. In addition, a failure of the magnetic field sensor or of the acceleration sensor unit can be detected. Should a failure occur, it is still possible to ascertain the speed using the remaining data.

Advantageously, according to an example embodiment of the present invention, it is further provided that the evaluation unit is designed to perform different speed ascertainments as a function of the rotational speed. In particular, below a predefined speed threshold of the rotational speed it is provided to fuse the signals of the magnetic field sensor and the acceleration sensor unit. This is done in particular as described before, i.e., with a fusion unit, in particular a Kalman filter. In this way, a rotational speed and/or orientation of the magnetic field sensor and/or acceleration sensor unit with respect to the axis of rotation can be ascertained from the fused signals. Especially at low speeds, this increases the accuracy of the speed ascertainment. This is advantageous for bicycles, where ascertaining the speed at low speeds is difficult. Above the speed threshold, it is provided to perform a first speed ascertainment based on signals of the magnetic field sensor and a second speed ascertainment based on signals of the acceleration sensor unit. This is done in particular as described above. The evaluation unit is preferably designed to output an error message if the results of the first speed ascertainment and the second speed ascertainment differ by more than a predefined tolerance. Especially in the case of bicycles with electric motor support, an accurate ascertaining of the speed is relevant even at higher speeds in order to comply with legal requirements, such as a maximum speed for the motorized support. Manipulation of the magnetic field measurement can be reliably detected on the basis of the acceleration measurement.

Preferably, according to an example embodiment of the present invention, the magnetic field sensor is designed for at least biaxial ascertaining of magnetic fields. In particular, it is not necessary to ascertain the magnetic field in the direction of the axis of rotation, since this field is not subject to changes due to the rotation of the magnetic field sensor. Alternatively or in addition, the acceleration sensor unit is preferably designed for the at least biaxial ascertaining of accelerations. Here as well, ascertaining the component along the axis of rotation is not necessary for the ascertaining of the rotation parameters of the acceleration sensor unit. In an alternative advantageous embodiment, the magnetic field sensor and/or the acceleration sensor unit are designed for triaxial ascertaining. In this way, for example measurement results can be plausibilized.

The magnetic field sensor is preferably designed to acquire at least two components mₓ and m_{y} of the earth's magnetic field in a coordinate system xyz that rotates about the axis of rotation, as follows:

mₓ=A(ψ)×cos(2πft+φ₁)

m_{y}=A(ψ)×sin(2πft+φ₁)

The components that are at least acquired, mₓ and m_{y}, are preferably oriented perpendicular to the axis of rotation. Optionally, a third component m_{z} of the earth's magnetic field in the direction of the axis of rotation can also be acquired, as follows:

m_{z}=B(ψ)

Here, A(ψ) and B(ψ) are absolute values of the magnetic field for direction of travel ψ, and φ₁ is a mounting angle of the magnetic field sensor. The absolute values A(ψ) and B(ψ) are a function of the earth's magnetic field and thus of the orientation of the axis of rotation. However, these values are not relevant for the ascertaining of the speed. Rather, the evaluation unit is designed to ascertain the frequency f from the components mₓ and m_{y} and from this to ascertain the rotational speed w according to the following relationship:

ω=2×π×f

The coordinate system xyz is oriented in such a way that the z-axis corresponds to the axis of rotation. The x-axis and the y-axis thus rotate around the z-axis, i.e. the axis of rotation. The coordinate system is preferably stationary with respect to the magnetic field sensor and/or the acceleration sensor unit.

The components mₓ and m_{y} represent oscillations, where the oscillation frequency f is a function of the rotational speed, as can be seen from the above equation. In this way, the evaluation unit can ascertain the speed easily and reliably.

Alternatively or in addition, it is provided that the acceleration sensor unit is designed to acquire the accelerations in said rotating coordinate system xyz as follows:

aₓ=a_{centr}−g′×cos(ωt+φ₂)

a_{y}=−g′×sin(ωt+φ₂)

The centrifugal acceleration a_{centr} used therein can be ascertained by a_{centr}=ω²r. Here g′ is the portion of the gravitational acceleration g in the plane orthogonal to the z-axis, which is in particular parallel to the axis of rotation, and r is the distance between the axis of rotation and the acceleration sensor unit, the evaluation unit being designed to ascertain the rotational speed ω from the accelerations aₓ and a_{y}. Again, the measured values are oscillations that are functions of the speed of rotation ω. In addition, there is the centrifugal acceleration a_{centr}, which is produced solely by the rotation about the axis of rotation. The acceleration sensor unit can ascertain other components of the acceleration, which however are preferably negligible. This measurement is particularly advantageous at low rotational speeds, since in this case the centrifugal acceleration a_{centr} is preferably also negligible, or goes approximately to zero.

The present invention also relates to a bicycle. The bicycle has at least one wheel that is rotatable about an axis of rotation. In addition, the bicycle has a sensor system as described above. The magnetic field sensor and the acceleration sensor unit of the sensor system are each attached to a wheel, in particular to the same wheel of the bicycle. The axis of rotation of the respective wheel here corresponds to the axis of rotation of the sensor system. Thus, the speed of rotation of the wheel and thus the speed of the bicycle can be ascertained by the sensor system.

### BRIEF DESCRIPTION OF THE DRAWINGS

In the following, exemplary embodiments of the present invention are described in detail with reference to the figures.

FIG. 1 shows a bicycle according to an exemplary embodiment of the present invention, having a sensor system.

FIG. 2 shows a schematic view of a sensor system according to a first exemplary embodiment of the present invention.

FIG. 3 shows a schematic overview of the sensor system according to the first exemplary embodiment of the present invention.

FIG. 4 shows a schematic view of a sensor system according to a second exemplary embodiment of the present invention.

FIG. 5 shows a schematic overview of the sensor system according to the second exemplary embodiment of the present invention.

### DETAILED DESCRIPTION OF EXAMPLE EMBODIMENTS

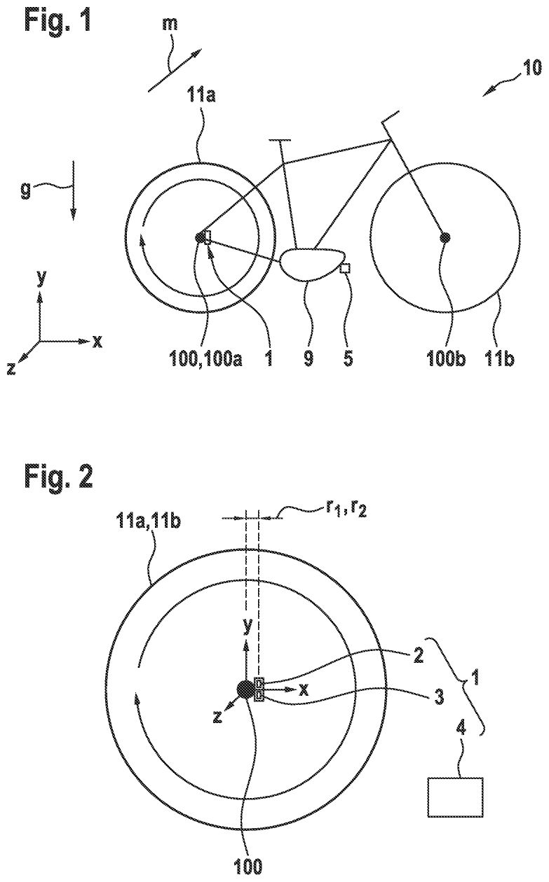

FIG. 1 shows a bicycle 10 according to an exemplary embodiment of the present invention. Bicycle 10 has a first wheel 11a and a second wheel 11b, one of the wheels 11a, 11b preferably being drivable both by muscular force of a user and by an electric drive 9. Bicycle 10 is thus preferably an e-bike. Bicycle 10 further has a sensor system 1 for ascertaining a speed of bicycle 10.

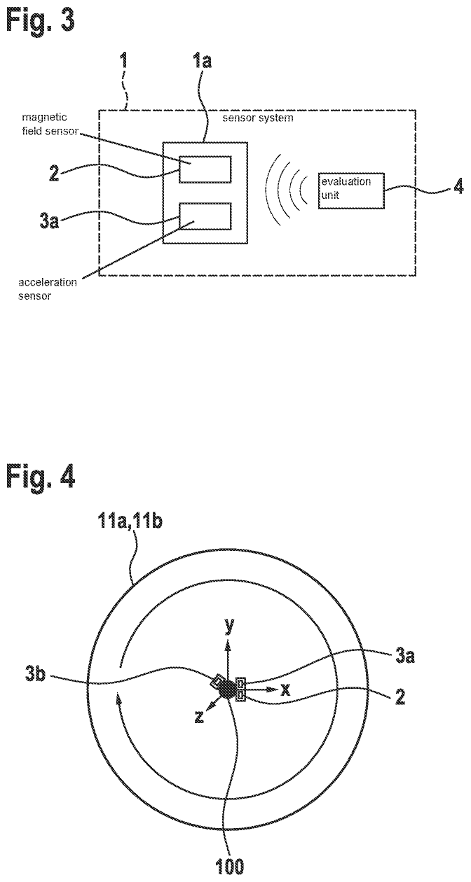

First wheel 11a is rotatable about a first axis of rotation 100a, and second wheel 11b is rotatable about a second axis of rotation 100b. Sensor system 1 has a magnetic field sensor 2 (cf. FIGS. 2 to 5) and an acceleration sensor unit 3 (cf. FIGS. 2 to 5) having at least one acceleration sensor 3a, 3b. Magnetic field sensor 2 and acceleration sensor unit 3 are fixed relative to each other and are situated at a predefined distance r₁, r₂, r₃ with respect to an axis of rotation 100 (cf. FIG. 2 and FIG. 5). Thus, magnetic field sensor 2 and acceleration sensor unit 3 are rotatable about axis of rotation 100. It is preferably provided that magnetic field sensor 2 and acceleration sensor unit 3 are situated on a hub of the first wheel 11a and/or second wheel 11b, so that axis of rotation 100 corresponds to the respective axis of rotation 100a, 100b of the wheel 11a, 11b.

Due to this configuration, on the one hand there is a magnetic field sensor 2 that rotates relative to the earth's magnetic field m, while on the other hand there is at least one acceleration sensor 3a, 3b that rotates relative to the earth's gravitation g and on which a centrifugal acceleration acts. On the basis of these sensors, the speed of bicycle 10 can be optimally determined.

In all exemplary embodiments, it is shown that magnetic field sensor 2 and acceleration sensor unit 3 are situated on first wheel 11a. Alternatively, magnetic field sensor 2 and acceleration sensor unit 3 can also be situated on second wheel 11b, or on different wheels 11a, 11b. All the Figures use the same coordinate system. Here, the z-axis is axis of rotation 100. The x-axis is oriented orthogonal to the z-axis, and the y-axis is oriented orthogonal to the z-axis and to the x-axis, the coordinate system being moved and rotated together with the wheel 11a, 11b.

FIG. 2 schematically shows a sensor system 1 according to a first exemplary embodiment of the present invention, FIG. 2 additionally showing its situation on a wheel 11a, 11b of bicycle 10. Sensor system 1 according to the exemplary embodiment of the present invention can be used as a sensor system 1 as shown in FIG. 1.

As described above, sensor system 1 has a magnetic field sensor 2 and an acceleration sensor unit 3, which in the first exemplary embodiment has a single acceleration sensor 3a. Magnetic field sensor 2 and acceleration sensor 3 are rotatable about axis of rotation 100, or about axis of rotation 100a, 100b of wheel 11a, 11b. A first distance r₁ of acceleration sensor 3a to axis of rotation 100 and a third distance r₃ of magnetic field sensor 2 to axis of rotation 100 are preferably the same, but can also be different.

Furthermore, sensor system 1 has an evaluation unit 4 that is designed to detect signals from magnetic field sensor 2 and acceleration sensor unit 3, i.e. acceleration sensor 3a. Advantageously, this is done via a wireless connection if the evaluation unit 4—as shown in the first exemplary embodiment—does not rotate with the wheel 11a, 11b, but is situated fixedly on bicycle 10. Alternatively, evaluation unit 4 can also be fastened on wheel 11a, 11b so as to rotate with it. In this case, a permanent wired connection of magnetic field sensor 2 and acceleration sensor unit 3 to the evaluation unit is preferably provided.

Evaluation unit 4 is thus set up to ascertain, using magnetic field sensor 2, at least those individual components mₓ, m_{y} of the earth's magnetic field m that are oriented perpendicular to axis of rotation 100, and in particular also the component m_{z} parallel to axis of rotation 100, in the co-rotating coordinate system xyz, as follows:

mₓ=A(ψ)×cos(2πft+φ₁)

m_{y}=A(ψ)×sin(2πft+φ₁)

m_{z}=B(ψ)

Here, A(ψ) and B(ψ) represent absolute values of the magnetic field in the direction of travel ψ. In addition, the components mₓ and m_{y} are functions of a first mounting angle φ₁ of magnetic field sensor 2.

The signals mₓ and m_{y} thus represent oscillations, where a frequency f of these oscillations is a function of the rotational speed ω=2×n×f of the wheel 11a, 11b. This oscillation is measured because the magnetic field sensor, which is fixed to the wheel 11a, 11b, rotates within the earth's magnetic field m. The oscillations also have the amplitude A(ψ), which is a function of the direction of travel ψ of the wheel 11a, 11b. Since the z-axis represents the axis of rotation 100, m_{z} is approximately constant B(ψ) but is also a function of the direction of travel ψ. The amplitudes A(ψ) and B(ψ) are, in addition to the direction of travel, also a function of the position of the wheel 11a, 11b on the earth, because both the amplitude and the vertical component of the earth's magnetic field m are a function of the position. The absolute values of the amplitudes A(ψ) and B(ψ) are not relevant for the further course.

The evaluation unit 4 is thus made able to ascertain the rotational speed ω of the wheel 11a, 11b on the basis of the magnetic field sensor 2, and a speed of bicycle 10 can also be calculated if the wheel circumference of the wheel 11a, 11b is known.

As a further possibility for ascertaining the rotational speed ω,acceleration sensor 3a is provided. Due to the mounting on the wheel 11a, 11b, for example on the wheel hub, a centrifugal acceleration a_{centr} acts on the acceleration sensor 3a during a rotation, which acceleration is a function of the rotational speed ω of the wheel 11a, 11b. In the first exemplary embodiment, acceleration sensor 3a is located at a position with coordinates (r₁,0,0). Here, r₁ represents the distance of acceleration sensor 3a to the axis of rotation 100, as described.

This centrifugal acceleration a_{centr} is described by the following equation:

a_{centr}=ω²r₁

The centrifugal acceleration a_{centr} acts exclusively in the direction of the co-rotating x-axis.

Furthermore, acceleration sensor 3a is additionally acted upon by the component g′ of the acceleration due to gravity g in the plane orthogonal to the axis of rotation. In the co-rotating coordinate system xyz, the component g′ of the acceleration due to gravity g is divided into two components:

a_{x,g}=−g′×cos(ωt+φ₂)

a_{y,g}=−g′×sin(ωt+φ₂)

Here, φ₂ is an angular offset of acceleration sensor 3a due to its mounting, and t is continuous time. The component g′ of the acceleration due to gravity g is a function of an angle of inclination of the bicycle.

In addition, other components are included in the measured values of acceleration sensor 3a. These are the longitudinal acceleration a_{d} of bicycle 10 in the direction of travel, for example due to braking or accelerating, as well as the vertical acceleration aᵤ in the vertical direction, for example due to impacts caused by an uneven ground surface. These additional accelerations are also divided into two components:

a_{x,f}=a_{d}×cos(ωt+φ₂)−aᵤ×sin(ωt+φ₂)

a_{y,f}=a_{d}×sin(ωt+φ₂)+aᵤ×cos(ωt+φ₂)

For a rotational speed ω there then results, for the signals aₓ₁ and a_{y1} of acceleration sensor 3a:

aₓ₁=a_{centr}+a_{x,g}+a_{x,f}

a_{y1}=a_{y,g}+a_{y,f}

The components a_{x,f} and a_{y,f} are small compared to the useful signal a_{centr}∓a_{x,g} or a_{y,g}. The useful signal in turn represents an oscillation that is a function of the rotational speed w of the wheel 11a, 11b. For known r₁, from the two signals aₓ₁ and a_{y1} the rotational speed w can be estimated.

The rotational speed ω can thus be asceratined using two independent measurement principles. This enables several advantages, which are described below:

At low speed, the direction of travel ψ of bicycle 10 can change quickly. The functional dependence of the signals of magnetic field sensor 2 on the direction of travel ψ thus makes it difficult to determine the current position or speed. Using a suitable fusion algorithm, such as a Kalman filter, which advantageously combines the signals of magnetic field sensor 2 with those of acceleration sensor 3a, not only the speed of bicycle 10 per revolution of the wheel 11a, 11b but also the angular position of the wheel 11a, 11b at any time within a wheel revolution can be better estimated. In this way the instantaneous speed can be better determined, in addition to the average speed. At low speed, the accelerations aᵤ and a_{d} and also the centrifugal acceleration a_{centr} are small compared to the component g′ of the acceleration due to gravity g in the plane orthogonal to the axis of rotation, so that approximately the following holds:

aₓ₁=a_{x,g}

a_{y1}=a_{y,g}

From this approximation it is then easy to determine the rotational speed ω of the wheel 11a, 11b, and thus the speed of bicycle 10.

At higher speeds, it is advantageously provided to acquire the acceleration components a_{d} and aᵤ with the aid of an additional non-rotating additional acceleration sensor 5 (see FIG. 1). The latter is already often included in the drive unit of the e-bike in order to realize various support functions. For known a_{d} and aᵤ, the rotational speed w can thus be determined from aₓ₁ and a_{y1}, sensor system 1 itself not requiring any further acceleration sensor.

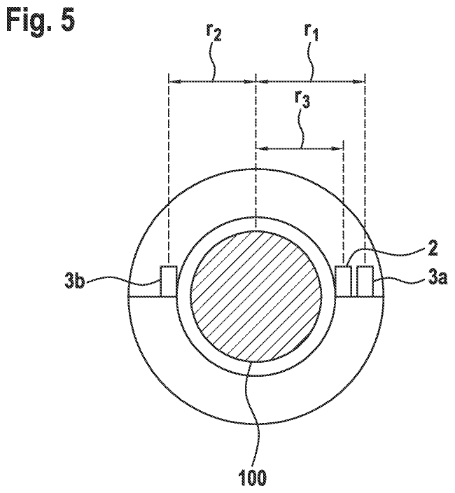

FIG. 4 and FIG. 5 show sensor system 1 according to a second exemplary embodiment of the present invention. In contrast to the first exemplary embodiment of the present invention, two acceleration sensors 3a, 3b are provided. Both a first acceleration sensor 3a and a second acceleration sensor 3b are attached to wheel 11a, 11b so as to rotate along with it. Here, magnetic field sensor 2, first acceleration sensor 3a, and second acceleration sensor 3b are stationary relative to each other. First acceleration sensor 3a and second acceleration sensor 3b have an angular offset to each other.

At higher speeds, the above approximation no longer holds; i.e., the components a_{d} and aᵤ can no longer be disregarded. Using the second acceleration sensor 3b, these components can also be ascertained or taken into account in the calculation of the rotational speed w of the wheel 11a, 11b.

It is particularly advantageously provided that first acceleration sensor 3a and second acceleration sensor 3b are configured in mirror-symmetrical fashion with respect to axis of rotation 100, as shown in FIG. 5. In this case, a first distance r₁ of first acceleration sensor 3a to axis of rotation 100 is the same as a second distance r₂ of second acceleration sensor 3b to axis of rotation 100. A third distance r₃ of magnetic field sensor 2 to axis of rotation 100 can also be the same, but can also be different. For the acceleration measured by the second acceleration sensor 3b, this results in:

aₓ₂=a_{centr}−a_{x,g}−a_{x,f}

a_{y2}=−a_{y,g}−a_{y,f}

Then the rotational speed ω of the wheel 11a, 11b can be estimated using aₓ₁ and aₓ₂ without the influence of an external acceleration, because

aₓ₁+aₓ₂=2a_{centr}

In other words, all measured components of the acceleration with the exception of the centrifugal acceleration a_{centr} are averaged out when acceleration sensor unit 3 is constructed as in the second exemplary embodiment. This simplifies the ascertaining of the speed by the acceleration sensor unit 3.

For both the first exemplary embodiment and the second exemplary embodiment, the following holds:

If, at higher speeds, the speed of bicycle 10 is ascertained on the basis of acceleration sensor unit 3 (either by an additional stationary or co-rotating acceleration sensor), then the speed that was ascertained on the basis of magnetic field sensor 2 can be plausibilized. In the event of a deliberate disturbance of the magnetic field, for example with the aim of influencing the speed measurement, a discrepancy arises between the two ascertained speeds, since the speed ascertained on the basis of acceleration sensor unit 3 is not influenced by the disturbance of the magnetic field. This discrepancy can be recognized by evaluation unit 4 and used to initiate appropriate measures, such as interrupting the motorized support of the e-bike.

In case of a random disturbance of the earth's magnetic field m, evaluation unit 4 can use the speed ascertained by acceleration sensor unit 3 as a temporary fallback solution to achieve a fail-safe ascertaining of the speed.

What is claimed is:

1. A sensor system for a bicycle. comprising:
a magnetic field sensor, and an acceleration sensor unit having at least one acceleration sensor; and
an evaluation unit configured to acquire signals from the magnetic field sensor and the acceleration sensor unit;
wherein the magnetic field sensor and the acceleration sensor unit are configured for attachment to a wheel of the bicycle, the magnetic field sensor and the acceleration sensor unit being fixed relative to each other and being situated at a predefined distance with respect to an axis of rotation; and
wherein the evaluation unit is configured to evaluate the signals of the magnetic field sensor and the acceleration sensor unit to ascertain: (i) a rotational speed, and/or (ii) orientation, of the magnetic field sensor and/or acceleration sensor unit with respect to the axis of rotation.

2. The sensor system as recited in claim 1, wherein the acceleration sensor unit has a first acceleration sensor and a second acceleration sensor that are stationary relative to each other and are situated in different angular positions with respect to the axis of rotation.

3. The sensor system as recited in claim 2, wherein the first acceleration sensor and the second acceleration sensor are configured mirror-symmetrically with respect to the axis of rotation.

4. The sensor system as recited in claim 1, further comprising:
an additional acceleration sensor situated in stationary fashion with respect to the axis of rotation, the evaluation unit being configured to ascertain a centrifugal acceleration from the signals of the acceleration sensor unit based on signals of the additional acceleration sensor.

5. The sensor system as recited in claim 1, wherein the evaluation unit has a fusion unit, including a Kalman filter, configured to fuse the signals of the magnetic field sensor and the acceleration sensor unit to ascertain, from the fused signals: (i) the rotational speed, and/or (ii) the orientation, of the magnetic field sensor and/or acceleration sensor unit with respect to the axis of rotation.

6. The sensor system as recited in claim 1, wherein the evaluation unit is configured to carry out a first velocity ascertainment based on signals of the magnetic field sensor, and a second velocity ascertainment based on signals of the acceleration sensor unit, and to output an error message when results of the first velocity ascertainment and second velocity ascertainment differ by more than a predefined tolerance.

7. The sensor system as recited in claim 1, wherein the evaluation unit is configured to:
when the rotational speed is below a predefined speed threshold, fuse the signals of the magnetic field sensor and of the acceleration sensor unit using a fusion unit including a Kalman filter, to ascertain from the fused signals: (i) the rotational speed, and/or (ii) the orientation of the magnetic field sensor and/or acceleration sensor unit with respect to the axis of rotation, and
when the rotational speed is above the predefined speed threshold, carry out a first speed ascertainment based on signals of the magnetic field sensor, and a second speed ascertainment based on signals of the acceleration sensor unit, and output an error message when results of the first speed ascertainment and second speed ascertainment differ by more than a predefined tolerance.

8. The sensor system as recited in claim 1, wherein the magnetic field sensor is configured for at least biaxial ascertaining of magnetic fields and/or the acceleration sensor unit is configured for at least biaxial ascertaining of accelerations.

9. The sensor system as recited in claim 8, wherein: i) the magnetic field sensor is configured to acquire at least two components of the earth's magnetic field in a coordinate system rotating about the axis of rotation as follows, the components mₓ and m_{y} being oriented perpendicular to the axis of rotation:
mₓ=A(ψ)×cos(2πft+φ₁)
m_{y}=A(ψ)×sin(2πft+φ₁)
wherein A(ψ) is an absolute value of a magnetic field for direction of travel ψ and mounting angle φ₁ of the magnetic field sensor, and wherein the evaluation unit is configured to ascertain the frequency f from the components mₓ and m_{y} and from the frequency, to ascertain the rotational speed ω according to the following relationship:
ω=2λπ×f
and/or
(ii) the acceleration sensor unit is configured to acquire accelerations in a coordinate system (xyz) rotating about the axis of rotation as follows:
aₓ=a_{centr}−g′×cos(ωt+φ₂)
a_{y}=−g′×sin(ωt+φ₂)
wherein the centrifugal acceleration a_{centr}=ω²r, r is a distance between the axis of rotation and the acceleration sensor unit, and a component g′ of the acceleration due to gravity g in a plane orthogonal to the axis of rotation, the evaluation unit being configured to ascertain the rotational speed w from the accelerations aₓ and a_{y}.

10. A bicycle, comprising:
at least one wheel rotatable about an axis of rotation; and
a sensor system, including:
a magnetic field sensor, and an acceleration sensor unit having at least one acceleration sensor; and
an evaluation unit configured to acquire signals from the magnetic field sensor and the acceleration sensor unit;
wherein the magnetic field sensor and the acceleration sensor unit are configured for attachment to a wheel of the bicycle, the magnetic field sensor and the acceleration sensor unit being fixed relative to each other and being situated at a predefined distance with respect to an axis of rotation; and
wherein the evaluation unit is configured to evaluate the signals of the magnetic field sensor and the acceleration sensor unit to ascertain: (i) a rotational speed, and/or (ii) orientation, of the magnetic field sensor and/or acceleration sensor unit with respect to the axis of rotation;
wherein each of the magnetic field sensor and the acceleration sensor unit is attached to the same wheel of the bicycle, and the axis of rotation corresponding to the axis of rotation of the same wheel.
